(19) United States
(12) Patent Application Publication
(10) Pub. No.: US 2007/0117587 A1
(43) Pub. Date: May 24, 2007

(54) Data read/write device capable of reading SIM card

(75) Inventor: Robert Tsao, Taipei City (TW)

Correspondence Address: Robert Tsao, 20525 Via Talavera, Yorba Linda, CA, 92887, US

(73) Assignee: Good Way Technology Co., Ltd.

(21) Appl. No.: 11/282,861

(22) Filed: Nov. 21, 2005

(51) Int. Cl. H04B 1/38

(52) U.S. Cl. 455/558

(57) ABSTRACT

A data read/write device capable of reading SIM (Subscriber Identity Module) card includes a SIM card slot, into which a SIM card is inserted and read; an internally provided SIM card connector for transmitting data of the SIM card inserted in the SIM card slot; a microprocessor for receiving and reading data of a SIM card transmitted from the SIM card connector, and a SIM card carrier detect (CD) pin provided between the SIM card connector and the microprocessor for detecting any SIM card in the SIM card slot. The SIM card CD pin is capable of informing the microprocessor to stop reading data of SIM card when the SIM card is withdrawn from the SIM card slot, so that the microprocessor is prevented from burning out due to faulty operation or falling into infinite loop of reading.

### FIELD OF THE INVENTION

The present invention relates to a data read/write device capable of reading SIM (Subscriber Identity Module) card, and more particularly to a data read/write device capable of reading SIM card that automatically stops reading data of a SIM card when a SIM card carrier detect (CD) pin in the device detects the SIM card is withdrawn from the device, preventing a microprocessor of the device from burning out due to faulty operation or falling into infinite loop of reading.

### BACKGROUND OF THE INVENTION

There are some data read/write devices allowing hot attach and detach being currently available in the market, such as USB card readers, externally connected hard disks, USB flash disks, etc. These data read/write devices are generally designed for connecting to a USB socket on a computer host to allow the purpose of plug and play, so that data transmitted between the computer host and the data read/write device could be quickly read and written, and users may conveniently carry the data along with them.

Currently, with the highly developed Internet that provides tremendous quantities of information, and the functionally largely improved mobile phones, a lot of people would use computers to download data and information from the Internet, and use SIM cards of the mobile phones as an interface to download pictures, moving pictures, music, directories, etc. from the Internet.

Meanwhile, the era of one person with multiple SIM cards and mobile phones is coming to also create tremendous trading opportunities via the Internet. For example, it has become popular to pay a small-amount on-line purchase using the SIM card. Some of the users would use different SIM cards to pay more than one small-amount on-line purchase. The mobile phone system providers would pay the money of on-line purchase via the mobile phone number and then collect the paid money from the user by sending a monthly phone bill to the user.

Conventionally, when a user wants to change the SIM card to another one, he or she has to switch off the mobile phone or the data read/write device first. In the event the SIM card is exchanged without switching off the mobile phone or the data read/write device, a microprocessor of the mobile phone or the data read/write device tends to burn out due to faulty operation thereof, or fall into infinite loop of reading to bring inconveniences to the user.

It is therefore tried by the inventor to develop an improved data read/write device capable of reading SIM card to overcome, the drawbacks existed in the conventional devices for reading SIM card.

### SUMMARY OF THE INVENTION

A primary object of the present invention is to provide a data read/write device capable of reading SIM card, in which a microprocessor automatically stops reading data of a SIM card when a SIM card carrier detect (CD) pin in the device detects the SIM card is withdrawn from the device, so that the microprocessor of the device is prevented from burning out due to faulty operation or falling into infinite loop of reading.

To achieve the above and other objects, the data read/write device capable of reading SIM card according to the present invention includes a SIM card slot, into which a SIM card is inserted and read; an internally provided SIM card connector for transmitting data of the SIM card inserted in the SIM card slot; a microprocessor for receiving and reading data of a SIM card transmitted from the SIM card connector, and a SIM card carrier detect (CD) pin provided between the SIM card connector and the microprocessor for detecting any SIM card in the SIM card slot. The SIM card CD pin is capable of informing the microprocessor to stop reading data of SIM card when the SIM card is withdrawn from the SIM card slot, so that the microprocessor is prevented from burning out due to faulty operation or falling into infinite loop of reading.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a data read/write device capable of reading SIM card according to a preferred embodiment of the present invention;

FIG. 2 is a partially enlarged view of the data read/write device capable of reading SIM card of FIG. 1;

FIG. 3 is a block diagram of the data read/write device capable of reading SIM card according to the present invention;

FIG. 4 is a reference circuit diagram of the data read/write device capable of reading SIM card according to the present invention; and

FIG. 5 is a flowchart showing the operating procedures of a microprocessor in the data read/write device capable of reading SIM card according to the present invention.

### DETAILED DESCRIPTION OF THE PREFERRED EMBODIMENTS

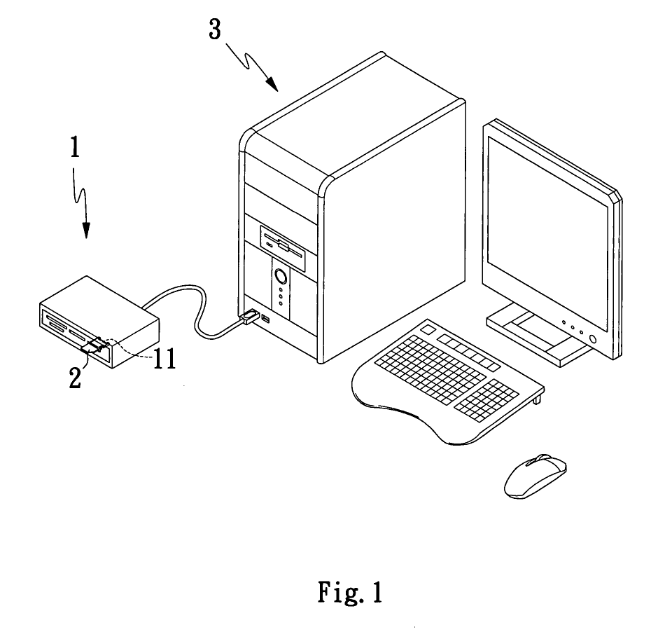

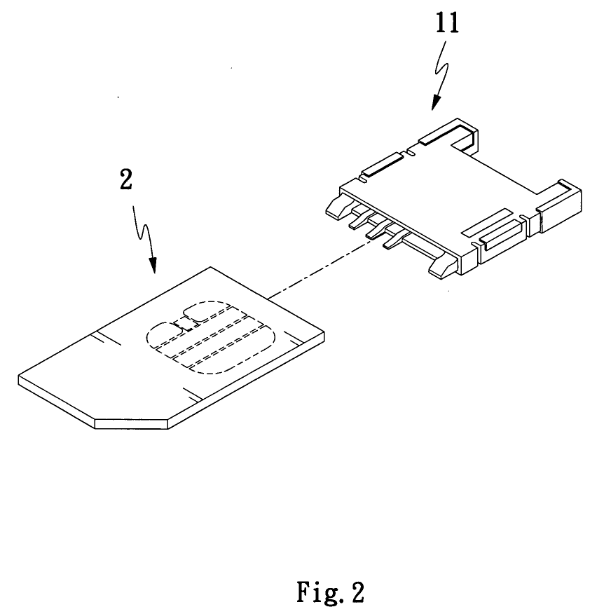

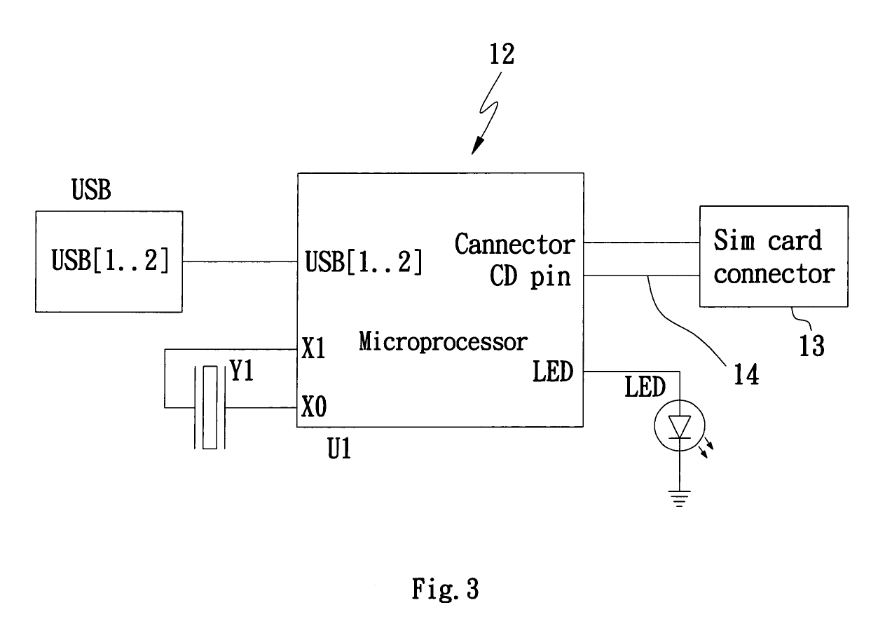

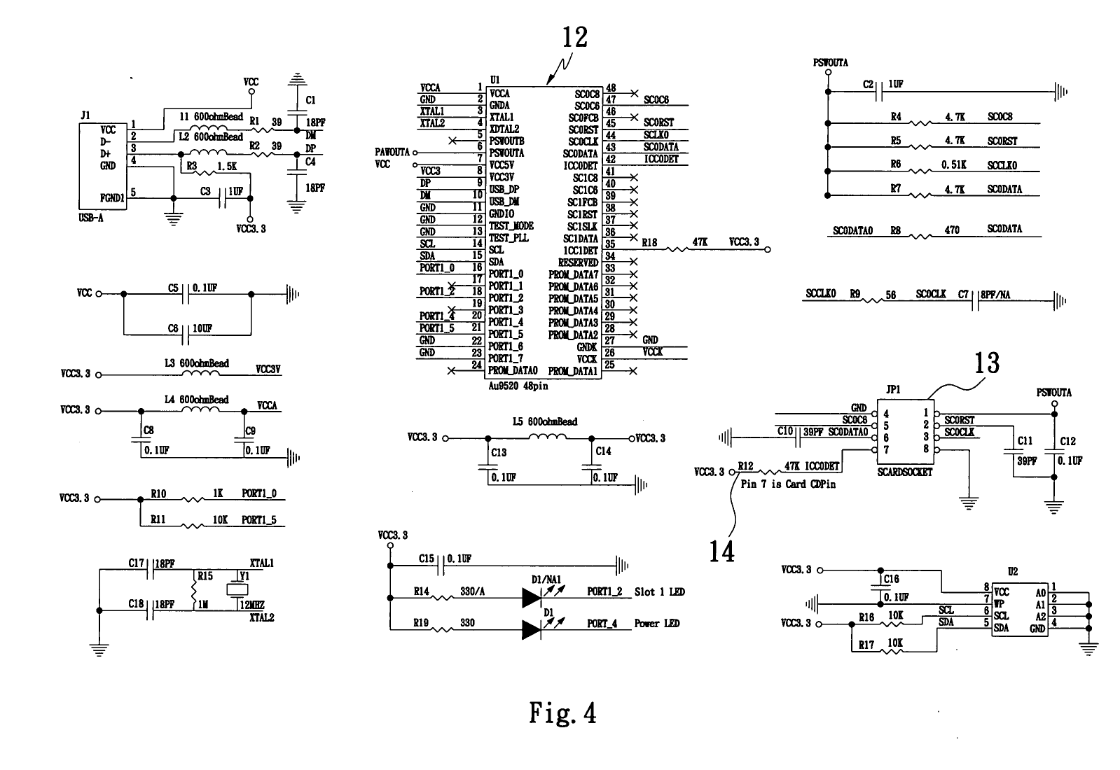

Please refer to FIG. 1 in which a data read/write device 1 capable of reading SIM card according to a preferred embodiment of the present invention is shown. The data read/write device 1 illustrated in FIG. 1 is a USB card reader. However, the data read/write device 1 may also be an externally connected hard disk, or a USB flash disk. The data read/write device 1 includes at least one SIM card slot 11 for reading data of a SIM card 2 inserted into the SIM card slot 11, as shown in FIG. 2. Please refer to FIGS. 3 and 4 that are block and reference circuit diagrams, respectively, of the data read/write device 1. The data read/write device 1 is internally provided with a SIM card connector 13, which transmits data read from the SIM card 2 inserted into the SIM card slot 11 to a microprocessor 12 of the data read/write device 1. It is noted there is a SIM card carrier detect (CD) pin 14 provided between the microprocessor 12 and the SIM card connector 13.

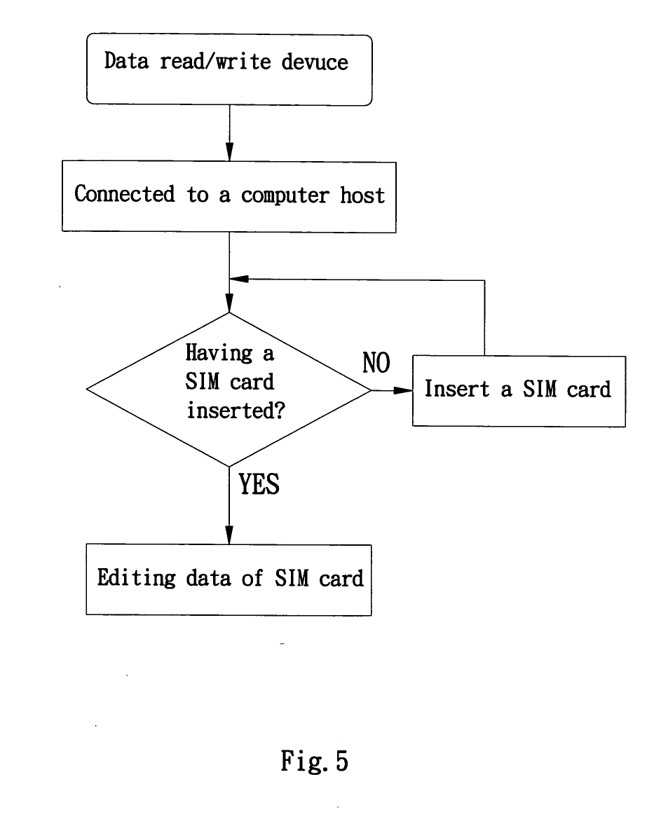

FIG. 5 is a flowchart showing the operating procedures of the microprocessor 12 of the data read/write device 1. As shown, when the data read/write device 1 is electrically connected to a computer host 3 (see FIG. 1), the microprocessor 12 in the data read/write device 1 uses the SIM card CD pin 14 to detect whether there is a SIM card 2 inserted in the SIM card slot 11. If no SIM card 2 is detected, the SIM card CD pin 14 would keep detecting until a SIM card 2 is inserted into the SIM card slot 11. When a SIM card 2 is detected, the microprocessor 12 would start editing data of the inserted SIM card 2. In the event the SIM card 2 is withdrawn from the slot 11 while the microprocessor 12 is operating, the SIM card CD pin 14 would immediately inform the microprocessor 12 to stop reading data from the SIM card 2, preventing the microprocessor 12 from burning out due to faulty operation, or falling into infinite loop of reading.

With the data read/write device 1, a user may use different SIM cards held by the user to pay more than one small-amount on-line purchase. Therefore, the current SIM cards may work as a small-amount credit card for use in general convenient stores to check out without the need of signing any bill.

What is claimed is:

1. A data read/write device capable of reading SIM card, comprising a SIM card slot, into which a SIM card is inserted and read, an internally provided SIM card connector for transmitting data of said SIM card inserted in said SIM card slot, a microprocessor for receiving and reading data of a SIM card transmitted from said SIM card connector, and a SIM card carrier detect (CD) pin provided between said SIM card connector and said microprocessor for detecting a SIM card in said SIM card slot; said SIM card CD pin being capable of informing said microprocessor to stop reading data of SIM card when said SIM card is withdrawn from said SIM card slot, so that said microprocessor is prevented from burning out due to faulty operation or falling into infinite loop of reading.

2. The data read/write device capable of reading SIM card as claimed in claim 1, wherein said data read/write device comprises a USB card reader.

3. The data read/write device capable of reading SIM card as claimed in claim 1, wherein said data read/write device comprises a hard disk.

4. The data read/write device capable of reading SIM card as claimed in claim 1, wherein said data read/write device comprises a USB flash disk.
